(19) United States
(12) Patent Application Publication
(10) Pub. No.: US 2007/0279779 A1
(43) Pub. Date: Dec. 6, 2007

(54) COLOR WHEEL

(75) Inventors: Michael John Milbourne, El Granada, CA (US); Othmar Zuger, Triessen (LI)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 11/737,387

(22) Filed: Apr. 19, 2007

Related U.S. Application Data
(60) Provisional application No. 60/746,174, filed on May 2, 2006.

(30) Foreign Application Priority Data
May 2, 2006 (DE) 10 2006 020 648.7

(51) Int. Cl. G02B 5/22

(52) U.S. Cl. 359/892

(57) ABSTRACT

A color wheel includes a motor and attached color ring, which includes a hub, a carrier and filter segments for being inserted into a light path. The geometry of the carrier is such that circular rings exist where the top view of the carrier fits into the area of the circular rings. The corresponding circular ring with minimum area defines outer and inner radii. The filter segments are translucent and extend radially into the circle with inner radius to contribute to a ring shaped area that is translucent to the light path as said color ring is rotated. The hub is attached to the motor and provides rotation of the color ring about an axis. At least one of the filter segments is attached to said hub. The attachment is less rigid against centrifugal forces than the fixation of the segments to the carrier so that rotation of the color ring leads to radial compressive forces exerted on all filter segments.

### BACKGROUND OF THE INVENTION

1. Field of the Invention

The present invention relates to Color wheels used for projectors to generate color sequential illumination.

2. Description of Related Art

Devices of the aforementioned type are used in applications where periodic color changes need to be produced in rapid sequence. Examples of optical systems using such devices are for example picture generation devices or display arrangements. Rear or front projection systems for television systems are typical applications.

In order to produce the required rapid color changes, color filters are inserted into the optical light path in rapid sequence. For this purpose typically a disc-shaped hub is used that is equipped with circularly arranged filter segments on the periphery that form a ring.

In geometry, a (circular) segment is an area of a circle informally defined as an area which is “cut off” from the rest of the circle by a secant or a chord. The circle segment constitutes the part between the secant and an arc, excluding the circle's center.

In contrast to this, throughout this disclosure the word segment signifies a sector of a ring with an outer circular arc and an inner circular arc and two radial edges. The “inner circular arc” of segment according to the present disclosure may be modified and therefore considerably deviating form the inner circular arc of the original ring and even from the form of a circular arc.

This color ring is rotated around its central axis. Through fast rotation of the color ring the filter segments are alternatingly inserted into the optical path and removed from it and thereby the desired rapid color change is produced. In order to realize this rotation the color ring is fixed to a motor. Color ring and motor form a color wheel.

Because the picture generation device must be able to produce a high picture quality, the color changes must be executed very rapidly. This means that the filter segments must be moved through the light beam at very high speed. Fast rotation of the ring is mandatory. As a result large forces due to accelerations which are several hundred times larger than the acceleration g due to gravity act on the color ring and particularly on the sensitive filter segments; for particularly high picture qualities the accelerations can exceed 1000 g. In addition the radial concentricity of the device must be highly accurate in order to achieve a long operational life of the device. Such picture generation devices must also satisfy very high brightness requirements which can only be achieved with powerful light sources. Through these powerful light sources the color ring is subjected to correspondingly high temperatures of up to 100° C.

On the other side these products have very often to withstand temperatures as low as −20° C. or even below. This is often the case when the products are stored before they are sold. In addition for example during transportation around the world to the countries the projectors are sold they, and with them the color wheels, have to cope with such low temperature levels. Here often temperatures occur which are as low as −40° C. or lower.

For these reasons the holding power and filter stability of the filter segments must fulfill very demanding requirements. Broad-scale utilization in so-called low-cost display applications is only feasible if it becomes possible to produce the color wheel at very low costs despite the high quality requirements.

A color wheel with circularly arranged filter segments for use in picture generation devices is described in EP 0 615 146 A2. In this device the filter segments are mounted on a glass ring. One disadvantage with this optical element is the fact that when inserted into the optical path, a high intensity of light has to propagate through an area which is comprised of adhesive. Most adhesives do not withstand such intensity. Another disadvantage of this arrangement is that the glass ring is expensive. In addition, precise radial concentricity is difficult to achieve. The glass ring produces additional light loss which impairs the economy of the overall arrangement.

In addition color wheel arrangements are known that feature fixing elements such as frames or spokes between the segments, but these lower the overall transmission values of the color filter rings and limit the economy. In an alternative approach the spokes or spoke-like elements between the segments do not extend to the area of the segments which is supposed to be placed into the optical path. As a consequence there is no effect on the overall transmission.

However such spoke elements or spoke like elements need to be arranged on the disc shaped carrier in such a way that they are adapted to the number and the angular size of the filter segments. The number and the size of these segments is very often customized, which means that for every new model of projection unit these disc shaped carriers need to be adjusted, which results in a cost wise negative change of layout. This is as well true for arrangements that feature frames for the filter segments.

In U.S. Pat. No. 5,868,482 the plane color filter segments are bonded on the periphery of a circular carrier in such a way that the ring-shaped transparent area between the filter segments in the rotation direction is not interrupted by materials that are optically not transparent. The color filter segments are surface bonded to the carrier in a strip-shaped zone pointing toward the axis of rotation. Surface bonding exists only in a small ring zone area toward the center of the rotation, so that a major portion of the filter segment surface, viewed radially from the axis of rotation toward the outside, remains free as a transparent, ring-shaped useful zone. Additional fixing elements that would require openings such as holes in the filter segments can be eliminated completely.

Low operational speeds range from 400 rpm to <10000 rpm and are typically at about 7200 rpm. High operational speeds range from 1000 rpm to 2500 rpm and are typically at 14400 rpm. Dependent on the operational speed the choice of the adhesive used to bond the color filter segments to the carrier is of specific interest. Soft adhesives tend to delaminate when operational speeds are high. Stress analysis showed that rigid adhesives can lead to failure due to glass cracking when storage at cold temperature is simulated. One of the hypothesis, why such a cracking happens relates to the difference of the coefficients of thermal expansion (CTE) of the segment material and the material of the carrier.

US 2004/0006495 proposes an arrangement with an outer ring. As disclosed there the filters are adjacently attached to one another via an adhesive material in a manner to surround the annular disc. Unfortunately this means that the inner radius of the filter segments needs to follow the outer radius of the annular disc. In addition according to the disclosure, first an annular color wheel is formed by attaching the filters to the annular disc. In a second step the color wheel is placed in the engaging groove of the outer ring. Consequently the outer ring must be fabricated with some tolerance leading to gaps between the ring and the outer edge of the filter segments.

In US 2004/0006495 nothing is stated on the materials and their CTEs. Typically the annular disc has a higher CTE as compared to the filter segments. Cooling down and/or heating up this assembly between −20° C. and 100° C. will therefore with a high probability result in microcracks within the glass segments.

When the color wheel is rotating with high speed, the segments experience high centrifugal forces. Since they are fixed to the annular disc, they experience strong tensile forces. Typically the outer ring is formed of a material with a higher CTE as compared to the CTE of the material of the filter segment. Filter segments are typically glass segments and ring materials with CTE's equal or lower than the CTE of glass are difficult to find. If the CTE of the ring material is higher than the CTE of the filter segments, rotation in a high temperature atmosphere as described in '495 will cause the ring to expand more than the filter segments. Therefore the outer ring, attached to the filter segments will exert in addition tensile stress to the segments. Cracking of the filter segments then becomes even more probable.

U.S. Pat. No. 5,868,482 in its last paragraph as well mentions that as an additional protection device a protection ring can be arranged on the outer edge of the filter segments. It is not specified what kind of protection this ring should provide. In addition it is not specified whether and if yes how the outer ring is attached to the filter segments. U.S. Pat. No. 5,868,482 sees this for less critical requirements only, where the filters can be fixed by means of an elastic material that is clamped between the carrier and the filter segments. Carrier of the segments is here the motor hub. For highly critical requirements as is the case for high speed applications the reader is led away from this solution.

### SUMMARY OF THE INVENTION

Therefore there is a need for a color wheel based on typical materials and suitable for high rotational speed applications and able to withstand temperature ranges down from −20° C. up to at least 80° C. without being adversely affected.

It is therefore an objective of the present invention to provide such a color wheel as well as a method for fabricating such a color wheel.

The objective can be accomplished by modifying the outer ring solution known in the art. According to the present invention the color wheels known in the art should be changed in such a way that the tensile stress exerted on the color wheels during rotation is significantly decreased and preferably even changed into compression.

This is achieved by providing a color ring with a carrier for the filter segments, the geometry of the carrier being such that its top view fits into the area of a circular ring with minimum area, the circular ring thereby defining an outer radius and an inner radius.

Each of the filter segments should be, according to the present invention, extending radially into the inner circle of the circular ring to form a continuous translucent area being adapted to extend into the light path and being translucent relative to the light path as said color ring is rotated

the color ring further comprising a hub for rotating the color ring

the hub having a central axis and being rotatable about its central axis,

the hub being attached to said color ring in such a way that upon rotating the color ring the filter segments experience radial compressive forces or at least not the full amount of centrifugal tensile forces.

There are at least three different possibilities of realize this.

The first possibility is to provide for a contact between the outer ring and filter segments which significantly exceeds the rigidity between segments and hub. If a yielding contact between hub and segments is provided, the segments will be pressed into the carrier during rotation. Note that in this case the carrier is the outer ring and not the hub. The higher the rotational speed will be, the higher will be the pressure on the outer ring. However now compressive forces will be exerted on the segments and cracking of the filter segments will probably not occur. In its extreme embodiment, the segments are fixed only to the outer ring, it edges in close contact to that ring and kind of loosely sandwiched between features of the hub. According to one aspect of the present invention in order to assemble such a color wheel, the color ring is formed by fixing the filter segments to the outer ring before the hub is assembled to the ring.

The second possibility to accomplish that the tensile forces within the filter segments are reduced, eliminated or changed to compression is to assemble the color wheel in such a way that the ring, when the wheel is not rotated, exerts compression on the filter segments. This could for example be accomplished by choosing the inner diameter of the ring at room temperature slightly smaller than the outer diameter of segments already assembled to a hub. Then the outer ring, and only the outer ring, is heated up to a temperature above the operational range. By this the outer ring, due to thermal expansion increases and may now be attached to the color ring. When cooling down, the outer ring will have the tendency to decrease in size and therefore now will exert compression on the filter segments.

As the size of the outer ring further decreases when the temperature goes below zero degrees to for example −20° or even −40° it might be an advantage to provide for spacing between the segments or to assemble at −20° or even lower temperature.

The third possibility focuses on the use of materials with different CTE's for the outer ring and the motor hub. A stainless steel ring and an aluminum hub could for example be used with a UV adhesive that cures at room temperature (say 20° C.). When the assembly is heated during operation the stainless steel ring expands proportionately much less than the aluminum hub but overall slightly less than the aluminum hub so that the filter segments experience compression.

### FIGURE CAPTIONS

FIG. 1 shows in an isometric view a cut of a color ring for a color wheel according to a first embodiment of the present invention. Shown in a addition is the fixture (dotted lines) for assembling such a coloring

FIG. 2a shows the top view of a color ring for a color wheel according to a second embodiment of the present invention

FIG. 2b shows a cut along the line A-A′ in FIG. 2a

FIG. 2c shows a cut along the line B-B′ in FIG. 2a

FIG. 3 shows the central part of a cross section of the embodiment according to FIG. 2a

FIG. 4 shows schematically a setup of a projector according to the present invention using the inventive color wheel

### DETAILED DESCRIPTION

With the help of the figures and based on different examples the invention will now be described in more detail.

First an example of how a color wheel according to the present invention can be fabricated is given. Then different embodiments of color wheels according to the present invention are disclosed.

Typically the process to build color wheels according to the present invention starts with the fabrication of the different parts required. Required are filter segments, a motor, a hub and a ring shaped carrier.

Fabrication of the Filter Segments

Substrates for filter segments can be for example colored or coated glass sheets. The required geometry of the filter segments can be achieved by multiple processes including, but not limited to: machining, laser cutting or scribe and break processes. Out of these processes the segments often have an edge that is normal to the top and bottom planes of the segments. Segments typically share a common curvature for the outer circular arc. However the “inner circular arc” of the segments is variable and may even not have the form of a circular arc. The geometry of the “inner circular arc” may be adapted to the hub to be used for rotating the color ring. The filter segments often have different angles defined by the radial edges.

Fabrication of a Hub

Hubs may be for example machined metal, but can also be molded materials. The hubs have an area to be in contact with the segments and features to attach to the motor. According to some embodiment of the present invention the hub might even be part of the axis of the motor.

Fabrication of the Carrier.

In the following the carrier will be named outer ring despite the fact that the actual geometry of the carrier could lead to a top view which significantly deviates from the shape of a ring.

Many different geometries are possible for the cross section of the outer ring. Among these are flat profiles, L-shaped profiles with and without flat concentric ring or ring sectors, U-shaped, interrupted U-shaped, or V-shaped profiles. Preferably the material used for the outer ring is less brittle than the material used for the filter segments. Metals and among the metals Aluminum is an excellent choice, however outer rings made of plastic may be possibly used.

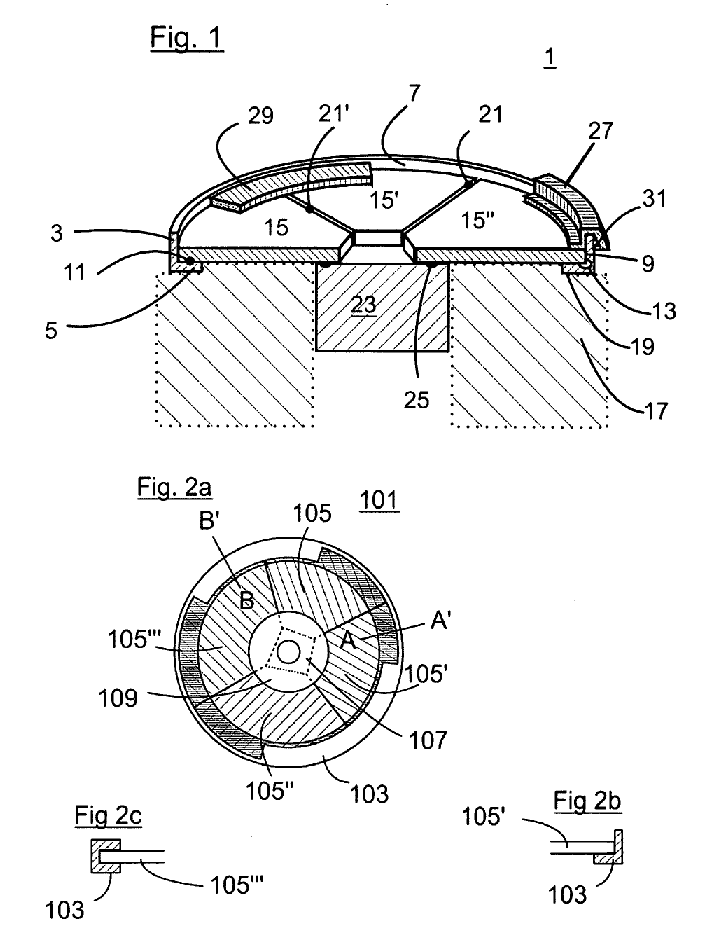

FIG. 1 shows a color ring 1 which together with a motor (not shown) forms a first embodiment of the present invention. In this first embodiment an outer ring 3 with L-shape is fabricated for filter segments which are 0.7 mm thick. It is an aluminum ring with outer diameter of 60 mm which is 1.5 mm thick in its thickest part in the radial direction and 2 mm thick in the axial direction.

According this embodiment the metal ring has a step 5 which has a thickness of 0.5 mm. This results into an L-shaped profile with diameters of 60 mm, 58 mm and 57 mm. The cylindrical surface with a diameter of 58 mm provides a primary bond area 9. The thin ring shaped surface which is the top of the step may provide a secondary bond area 11. Foreseen in the corner between primary bond area 9 and secondary bond area 11 might be a recess 13 where adhesive could be filled in. This in addition helps to assure that the segments flush in the corner and also has the added benefit of helping to reduce adhesive squeeze out.

According to the first embodiment the assembly of the color ring with the outer ring as described above is accomplished in the following manner:

A thin layer of adhesive is placed on the outer ring primary or secondary bond area or both bond areas, preferably, if given into the recess 13.

Adhesive is preferably not applied along the full rim section in order to minimize the stress in the adhesive due to different thermal expansion of segment, adhesive and outer ring. For example doted lines or discrete spots may be used.

In one embodiment these discrete spots are located at the endpoints of the outer circular arc of the segments where neighboring segments come together, because in these areas the optical active area is interrupted because of transition between two segments.

It is known that glass cracking occurs by propagation of microcracks at the edges into the glass. Therefore, according to another embodiment of the present invention, adhesive is applied to the secondary bond surface only and not applied to the primary bond surface in order to avoid that in the case of temperature variations the adhesive directly exerts local shear stress to the edges of the segments. In this case it is preferable to apply the adhesive well distant from the endpoints of the outer circle arcs of the segments, for example on the middle part.

The outer ring 3 is placed in a fixture for filter segments 15, 15′, 15″. This fixture 17 has a recess 19 due to material removal for fitting in the outer ring 3. This fixture 17 is designed so that a disc surface is of the same height as the step feature in the ring with a smaller outer diameter than the inner Diameter of the ring and a larger inner diameter than the outer dimensions of the hub. The filter segments 15,15′,15″ are placed on the disc surface and are slid into the primary bond surface of the outer ring. Preferably the segments have zero clearance to this surface.

It is possible to arrange the segments in close contact, however preferably they are spaced apart from each other with shims. Preferable gap thicknesses range from 0.01 mm up to 0.3 mm, however most preferred is the thickness 0.05 mm. The shims are used to maintain a uniform gap thicknesses 21, 21′ around the color ring. These gaps help to avoid that the segments exert stress on each other through the radial edges when the color wheel is cooled down to −20° or even −40° and the shrinkage of the hub is higher than the shrinkage of the segments due to the larger CTE of the hub.

In order to finally assemble the color ring a layer of adhesive is then placed on a hub 23.

The hub may comprise a recess 25 to receive adhesive. The hub 23 is inserted from the bottom of the fixture 19 and through the adhesive layer brought contact in with at least one of the filter segments 15,15′,15″.

For the question where to preferably locate the adhesive on the hub 23 the same considerations with the microcracks at the edges of the segments and the stress introduced by the adhesive hold for the attachment of the hub 23 to the segments 15,15′,15″. Therefore preferably the attachment is not located at the edges of the segments 15,15′,15″, but rather the bottom side somewhere distant from the edges of the filter segments 15,15′,15″.

The hub 23 is held in place and the resulting ring is tacked with UV radiation or could also be held in place using a fixture and using a heat cure adhesive or any other adhesive. The resulting color ring is removed from the fixture and placed in an oven to heat cure at a temperature at or above the upper specified operating limit of the color wheel. This places the zero stress state of the color ring at the high temperature if the color wheel is not rotating.

Due to the zero clearance of the filter segments 15, 15′, 15″ to the primary bond surface 9 of the outer ring 3 the attachment of the filter segments 15,15′,15″ to the outer ring 3 is automatically as rigid against centrifugal forces as an attachment can maximally be. This is not true for the attachment of the segments to the hub 23. Therefore it is ensured that upon rotation radial compression forces are exerted on all the segments.

Due to the gaps 21, 21′ between the filter segments, it is achieved that the segments don't exert stress upon each other at low or very low temperature.

Additional to the L-shaped outer ring a flat concentric ring (not shown) or one or multiple concentric ring sectors 27, 29 may be applied in order to additionally fix the filter segments to the outer ring. Such a ring sectors may be fixed to the filter segments using again adhesive.

A ring sector 27 may as well be attached to the outer ring 3 with the help of a snap mechanism. For the cylindrical surface 7 is slightly higher than the thickness of the filter segments 15,15′,15″ as shown in the figure. In addition the outer ring may provide a nose 31 and the ring sector 27 is formed in such a way that it wraps around the outer ring and snaps into the edge of the nose 31. In order to reduce the noise during operation not only a snapping ring sector 27 but a full snapping ring is preferably used.

On the basis of this snapping mechanism it is possible to fix the segments to the outer ring without adhesive. In order to realize this, the segments a placed into the outer ring and the snapping ring is attached to it. In this configuration there is however the need for means to assure that the segments don't slide with respect to each other. For this purpose shims may be foreseen in the outer ring and between the segments. Preferably such shims are formed from elastic material. It is preferable if these shims comprise a head snuggly fitting into a ring shaped groove 13 which is comprised in the outer ring. The groove is preferably formed in such a way that the head of the shim snaps into the groove, if pressed into the groove. With such a configuration the shims are fixed to the outer ring, but can slide along the outer ring. This principle corresponds to a rail.

FIG. 2a shows the top view of a color wheel 101 according to a second embodiment of the present invention. The outer ring 103 has the profile of an interrupted U-shape. In order to show this more clearly, FIG. 2b shows a cut along the line A-A′ and FIG. 2c shows a cut along the line B-B′. In this case the segments 105,105′,105″,105′″ inserted into L-shaped parts according to A-A′ and are slided into the U-shape according to B-B′. One of the L-shaped part must be at least as large as the largest of the segments 105,105′,105″,105′″. Because the segments 105,105′,105″,105′″ are assembled into the outer ring 103 before the assembly with a hub, the segments 105,105′,105″,105′″ can be slid in radially.

FIG. 2 shows in addition another possibility to realising the attachment of a hub to the segments 105,105′,105″,105′″ without glue. In this example part of the hub 107 as the form of a quadrangle. As mentioned before the “inner circle arc” of the filter segment can be modified considerably. Here the “inner circles arcs” of the segments 105,105′,105″,105′″ are modified in such a way that when the segments are put together their “inner circles arcs” follow the form of the hub 107. Since this is no more rotational symmetric, rotation of the hub 107 will directly result in rotation of the segments 105,105′,105″,105′″.

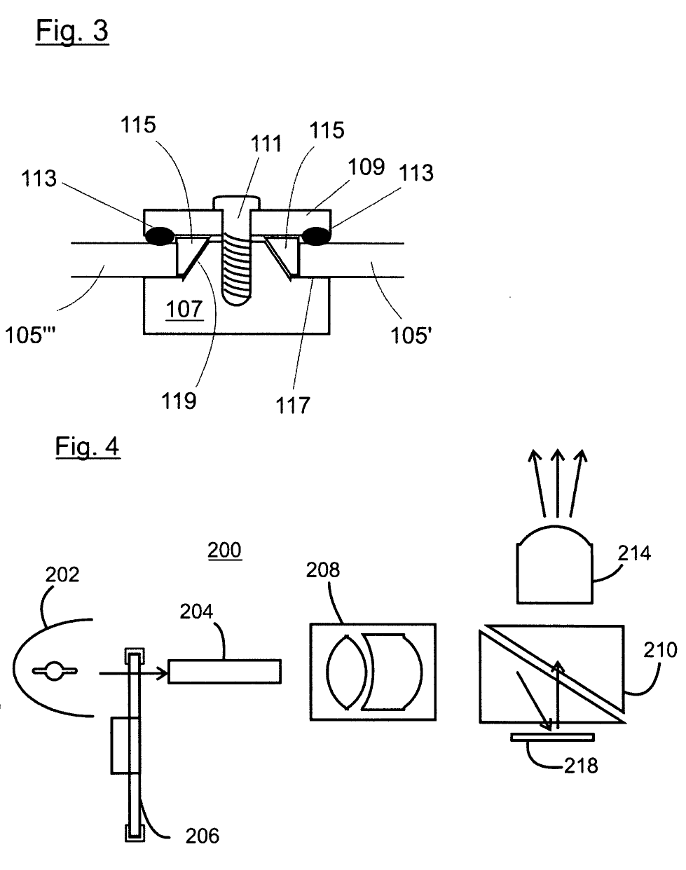

FIG. 3 shows a side cut of the assembly of FIG. 2. Only the central part of the color ring 101 is shown. Shown is the hub 107 as well as two filter segments 105′, 105′″. The hub has a recess 117 where the filter segments fit in. The side walls 119 of the recess 117 in this example has slightly pyramidal shape because the basis is a quadrangle. In its center hub 107 has a screw thread which is the counterpart of a screw 111 of a cap 109. The cap 109 has on its bottom side elastic features 113. This could be elastic material or per se or something formed to an elastic shape. When screwing the cap 109 to the hub 107 the elastic features press down on the filter segments. Provided on the cap in addition are elastic wedge 115 which slide along the side walls 119 of the recess 117 provide force to the filter segments which is directed radial away from the center.

FIG. 4 shows a projection display 200. Such a system may be used for a front or rear projection system or the like. An example of a suitable application is the television.

Lamp 202 provides light which is integrated by integrator 204. Integrator 204 is, for example, a hollow path formed by four inward facing mirrors. Light from lamp 202 bounces off the mirrors many times, so that a uniform rectangular field of light is formed at the exit of integrator 204. The color wheel 206 is designed to provide the correct color of light when Spatial Light Modulator (SLM) 218 is set to program that color. Shown without additional reference is as well the outer ring. Downstream the optical path there are illumination lenses 208 which act to project the uniform field at the output of integrator 204 onto the SLM 218, via prism 210. The spatially modulated light is then provided to projection lens 214.

The whole description focused on transmissive color wheels. However the same principle may be applied to color wheels based on reflection. If for example the filter segments are colored with the help of thin film interference filters, color selection will mainly happen through selective transmission and reflection of light. Therefore such a transmissive color wheel is at the same time a reflective color wheel, and in some projectors the operation mode of the color wheel is in reflection. In addition there are color wheels which not exclusively have translucent segments and for example comprise a black, light blocking segment.

The principle of the present invention may be advantageously applied as well to these color wheels. This is to be considered to be within the scope of the present invention.

The figures only show planar filter segments. However it should be noted that the idea according to the present invention may as well be applies to color wheels with segments which are not planar and comprise for example lenses or other structures.

The principle of the present invention may be advantageously applied as well to these color wheels. This is to be considered to be within the scope of the present invention.

What is claimed:

1. Color wheel with motor and color ring attached to the motor,
the color ring comprising a hub, a carrier and a plurality of filter segments rigidly attached to the carrier for being inserted into a light path,
the geometry of the carrier being so that circular rings exist where the top view of the carrier fits into the area of the circular rings, the corresponding circular ring with minimum area defining an outer radius and an inner radius,
each of the filter segments being translucent,
each of the filter segments extending radially into the circle with inner radius to contribute to a continuous translucent ring shaped area being adapted to extend into the light path and being translucent relative to the light path as said color ring is rotated
the hub being attached to the motor and provided for rotating the color ring
the hub having a central axis and being rotatable about its central axis
at least one of the filter segments being attached to said hub
the attachment being less rigid against centrifugal forces than the fixation of the segments to the carrier so that rotation of the color ring leads to radial compressive forces exerted on all the filter segments.

2. Color wheel according to claim 1 characterized in that at room temperature the segments are space apart by a slit by 0.01 mm to 0.3 mm.

3. Color wheel according to claim 1, characterized in that the hub comprises elastic means for fixing the hub to the filter segments, the elastic means exerting on the segments radial pressure to the outside.

4. Color wheel according to claim 3, wherein the hub is fixed to the filter segments without an adhesive.

5. Color wheel according to claim 1 characterized in that the filter segments are fixed to the carrier by a snapping ring.

6. Color wheel according to claim 5 characterized in that the carrier comprises elastic shims for spacing the segments with respect to each other.

7. Color wheel according to claim 6, characterized in that the shims comprise a head which interacts with a ring shaped groove comprised in the carrier, allowing to shift the segment to the locations as required.

8. Color wheel according to claim 1, wherein at room temperature the segments are spaced apart by a slit of approximately or exactly 0.05 mm.
